(19) United States
(12) Patent Application Publication
(10) Pub. No.: US 2025/0124194 A1
(43) Pub. Date: Apr. 17, 2025

(54) INTELLIGENT OPTIMIZATION OF SPACECRAFT MISSIONS

(71) Applicant: The Aerospace Corporation, El Segundo, CA (US)

(72) Inventors: Eric Joseph NEMANICK, Santa Monica, CA (US); Ann L. CHERVENAK, Los Angeles, CA (US); Joseph Z. FUERST, Beavercreek, OH (US)

(73) Assignee: The Aerospace Corporation, El Segundo, CA (US)

(21) Appl. No.: 18/486,805

(22) Filed: Oct. 13, 2023

(51) Int. Cl. G06F 30/27; G05D 1/10; G06F 111/04

(52) U.S. Cl. CPC G06F 30/27; G06F 2111/04

(57) ABSTRACT

Intelligent optimization of mission planning and execution for spacecraft through intelligent analysis of mission objectives and payload operation is disclosed. Values for mission objectives, payload operation, and/or vehicle conditions may be defined during given time periods, including variable values for repeat operations or other factors. These values may then be used through a vehicle/mission simulation agent to optimize the mission plan through maximizing the mission score according to the values. The simulation agent may identify possible mission plans based on vehicle capability, and then score the mission plan based on the total objective score.

### FIELD

The present invention generally relates to spacecraft mission analysis and planning, and more specifically, to intelligent optimization of mission planning and execution for spacecraft through intelligent analysis of mission objectives and payload operation.

### BACKGROUND

Current spacecraft mission planning relies on human-defined mission operations based on developing mission plans by hand, or on using limited simulations or projections of mission capabilities and constraints. Algorithmic optimization of missions through this process can be difficult since the process relies subjective evaluations of mission objectives or mission planning that only executes to the minimum required mission. The subjective value for a particular mission operation cannot be factored through conventional numeric optimization processes.

Subjective evaluation of payload benefits makes it difficult to quantify the mission value of operating payloads. Manually planned missions are slow to respond to changing mission needs, vehicle performance, and/or a dynamic environment. Without quantifiable metrics for mission operation, success, and value, numerical optimization of mission parameters and performance cannot be performed through software using algorithmic optimization processes. Accordingly, an improved and/or alternative approach may be beneficial.

### SUMMARY

Certain embodiments of the present invention may provide solutions to the problems and needs in the art that have not yet been fully identified, appreciated, or solved by current spacecraft mission planning technologies, and/or provide a useful alternative thereto. For example, some embodiments of the present invention pertain to intelligent optimization of mission planning and execution for spacecraft through intelligent analysis of mission objectives and payload operation.

In an embodiment, one or more non-transitory computer-readable media store one or more computer programs for intelligent optimization of mission planning and execution for one or more space vehicles through intelligent analysis of mission objectives and payload operation. The one or more computer programs are configured to cause at least one processor to generate possible mission plans, by a vehicle/mission simulation agent, by running mission/vehicle simulations based on parameters pertaining to operation of systems of the one or more space vehicles, payloads of the one or more space vehicles, operations of the one or more space vehicles, or a combination thereof. The one or more computer programs are also configured to cause the at least one processor to score the generated possible mission plans based on total objective scoring of individual values of component operations within the generated possible mission plans using the parameters, producing respective total objective scores. The one or more computer programs are further configured to cause the at least one processor to display a mission plan of the generated possible mission plans with a highest total objective score of the respective total objective scores.

In another embodiment, a computing system includes memory storing computer program instructions for intelligent optimization of mission planning and execution for one or more space vehicles through intelligent analysis of mission objectives and payload operation and at least one processor configured to execute the computer program instructions. The computer program instructions are configured to cause the at least one processor to define a scoring period for mission/vehicle simulations. The scoring period is a timeframe over which the mission is to be optimized. The computer program instructions are also configured to cause the at least one processor to collect payload operations for the one or more space vehicles and apply pairwise rankings to values for the collected payload operations to establish a relative value for each operation. The pairwise rankings use a common scale. The computer program instructions are further configured to cause the at least one processor to score possible mission plans based the pairwise rankings and display a mission plan of the generated possible mission plans with a highest total objective score of the respective total objective scores.

In yet another embodiment, a computer-implemented method for intelligent optimization of mission planning and execution for one or more space vehicles through intelligent analysis of mission objectives and payload operation includes generating possible mission plans, by a vehicle/mission simulation agent executing on a computing system, by running mission/vehicle simulations based on parameters pertaining to operation of systems of the one or more space vehicles, payloads of the one or more space vehicles, operations of the one or more space vehicles, or a combination thereof. The computer-implemented method also includes scoring the generated possible mission plans, by the computing system, based on total objective scoring of individual values of component operations within the generated possible mission plans using the parameters, producing respective total objective scores. The computer-implemented method further includes displaying a mission plan of the generated possible mission plans with a highest total objective score of the respective total objective scores, by the computing system. The running of the mission/vehicle simulations comprises analyzing power constraints, attitude constraints, communications bandwidth, thermal conditions, and orbital position.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a flow diagram illustrating a process for determining objective value functions for a mission, according to an embodiment of the present invention.

FIG. 2A is a graph illustrating ranked values for multiple operations over multiple iterations based on initial value functions for the operations, according to an embodiment of the present invention.

FIG. 2B is a graph illustrating ranked values for multiple operations over multiple iterations after user adjustments to the value functions for the operations, according to an embodiment of the present invention.

FIG. 3A illustrates an example of a neural network that has been trained to perform or supplement intelligent mission optimization, according to an embodiment of the present invention.

FIG. 3B illustrates an example of a neuron, according to an embodiment of the present invention.

FIG. 4 is a flowchart illustrating a process for training AI/ML model(s), according to an embodiment of the present invention.

FIG. 5 is flowchart illustrating a process for intelligent mission planning and execution for one or more space vehicles through intelligent analysis of mission objectives and payload operation, according to an embodiment of the present invention.

FIG. 6 is an architectural diagram illustrating a computing system configured to perform or supplement intelligent mission optimization, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to intelligent optimization of mission planning and execution for spacecraft through intelligent analysis of mission objectives and payload operation. Such embodiments allow a user/operator to define values for mission objectives, payload operation, and/or vehicle conditions during given time periods, with variable values for repeat operations or other factors as set by the user. These values may then be used through a vehicle/mission simulation agent to optimize the mission plan through maximizing the mission score according to the user-defined values. Tools such as the Advanced Global Optimisation Tool used by the European Space Agency (ESA) or the National Aeronautics and Space Administration's (NASA's) Scheduling Planning Routing Inter-satellite Network Tool (SPRINT), Trade-space Analysis Tool for Designing Constellations (TAT-C), or the NASA Operational Simulator for Small Satellites (NOS3) can help plan missions through simulation of vehicle and environmental parameters.

Unlike conventional mission planning, some embodiments extract the maximum mission value from a spacecraft without lengthy human-directed iteration, delivering more rapid results for the maximum achievable mission. To deconflict payload operations in an algorithmically optimizable process, a repeatable, quantifiable process is advantageous to value each operation and generate numerical values for particular operations and repeats of those operations on a numerical scale. Across a mission, there should be assurance that all units are optimized to the same value for goals and needs. A process that generates numerical values for particular spacecraft or mission operations can compare absolute values between operations, and more specifically, compare mission plans composed of those operations. These mission plans can then be iterated to generate the maximum mission value numerical value, delivering the optimal mission plan.

Such embodiments may be used for planning missions for multi-payload vehicles, such as Department of Defense (DoD) or NASA missions, increasing the amount of data that can be provided or science that can be achieved. Vehicles with multiple payloads and conflicting requirements and limits can be optimized during the mission. For instance, vehicle payloads, pointing, power draw, and orbital alignment can be optimized to maximize the amount of mission that is extractable against user-defined quantified objectives. Optimization of multiple vehicles across a constellation, or multiple different assets in a mission can be accomplished rapidly using high fidelity vehicle models. Rapid, dynamic updating of the mission plan in response to component failure, mission changes, or customer needs can also be performed. Trained software agents can respond to updated payload values. Optimization of candidate missions during the design phase can inform decisions on system margins, remove excess component capability, and deconflict payload needs, such as pointing and power.

In some embodiments, a vehicle/mission simulation agent generates possible mission plans based on operation of vehicle systems, payloads, or other operations, and then scores the mission plan based on the total objective scoring of the individual value of the component operations within the mission plan. In some embodiments, the simulation agent identifies possible mission plans based on vehicle capability, and then scores the mission plan based on the total objective score. Mission/vehicle simulation(s) are performed to evaluate the physical constraints of the spacecraft, such as power, attitude, communications bandwidth, thermal conditions, orbital position, etc. This allows mission designs to be bounded by spacecraft systems limitations. This also permits optimization of mission output through user-defined values of mission operations.

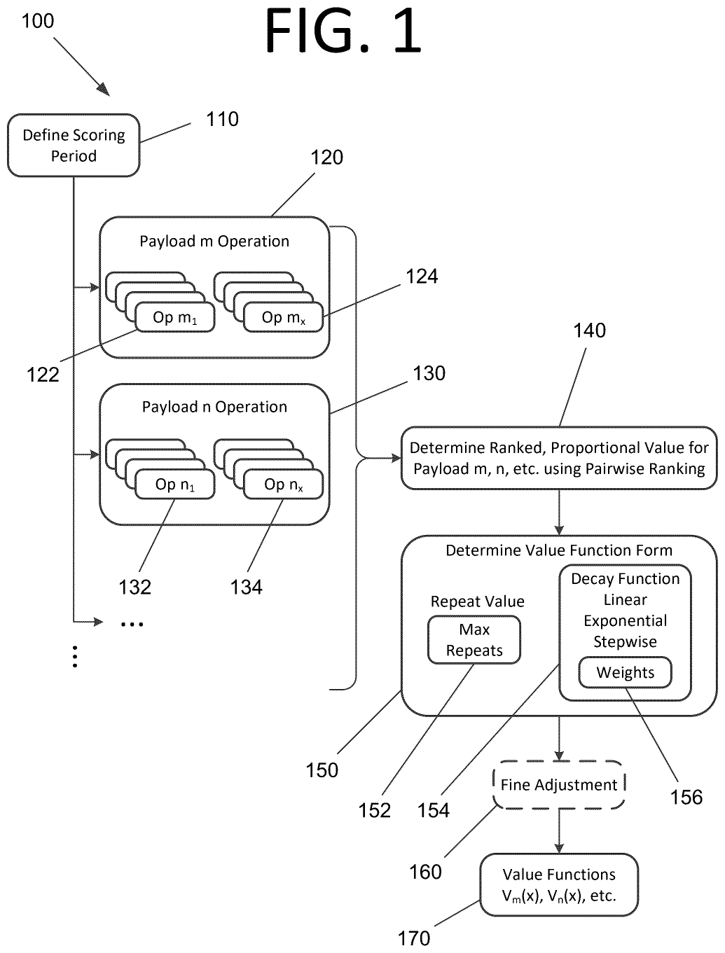

FIG. 1 is a flow diagram illustrating a process 100 for determining objective value functions for a mission, according to an embodiment of the present invention. The process begins with defining a scoring period at 110. This scoring period is defined as the timeframe over which the mission is to be optimized. For example, to devise optimal mission planning over one month, the scoring period would encompass that month, and evaluation of operations will concern the value of operations within that scoring period. The scoring period can be as short as 10 minutes in some embodiments, and extend to the life of the vehicle(s). The payload operations (or other mission operations such as pointing, tracking, charging, etc.) for the vehicle are collected. Pairwise ranking is applied at 140 to values for payload operations, such as m₁ 122, mₓ 124, n₁ 122, nₓ 124, etc. of payloads 120, 130, respectively, are used to determine ranked, relative values. For example, operation of a camera when over a certain target to be observed can be ranked relative to a laser communications array operation, a magnetometer pulse, a propulsion system prototype firing, and a stellar observation.

Pairwise ranking 140 establishes a relative value for each operation and its repeat. This process asks a user to rank each first instance of an operation through a pairwise process (e.g., ranking which is more valuable between process A and B, between process B and C, between process A and C, etc.) to generate a full ranked list of operations by user value. In some embodiments, rankings are also provided for each repeat of an operation in a time period (e.g., determining which is more valuable between process A₂ and B₁, between process B₂ and C₁, etc.). This may accommodate for a process becoming more or less valuable for multiple operations of a particular iteration. For instance, if process A is capturing images and process B is transmitting image data to a ground station, process B may increase in value over multiple iterations as more image data is captured for analysis. This may be used to generate a ranked choice list for all operations and their repeats in the timeframe. Absolute numerical value rankings are established by placing all operations on a scale (e.g., from 0 to 1, from 1 to 100, etc.).

For each operation family (e.g., 120, 130, etc.), a value function form is determined at 150. For instance, the user may be asked to provide a maximum number of repeats 152 of a particular operation. The user may be asked to choose a function type 154 (e.g., a decay function, a linear function, an exponential function, etc.) with associated weights 156 for function operation, etc. A decay function would have a decrease, a linear function would have a steady increase or decrease, an exponential function would have a rapid increase or decrease, a stepwise function would have a plateau followed by a sharp increase or decrease, etc. For example, a mission may use an atmospheric spectrometer operation. Each repeat operation of the spectrometer may decrease in value linearly as each successive operation still has value, but less value is delivered for each operation. This allows for operations that have consistent value to be separated from operations that have limited value for multiple operations, and for arranging of their values relative to one another.

Value function forms have been determined at 150, fine adjustments may be made by the user, if desired, at 160. For instance, the user may tweak the form of the value functions as desired. Value functions are then assigned for the operations at 170. An interface for this interaction may consist of XY graphs of the value of one or more operation versus time or versus repeat number (e.g., a value of 100 for the first operation, a value of 50 for the second operation, a value of 25 for the third operation, a value of 12 for the fourth operation, a value of 6 for the fifth operation, etc.). The user may be able to manually select particular values and increase or decrease the value of the repeat in some embodiments.

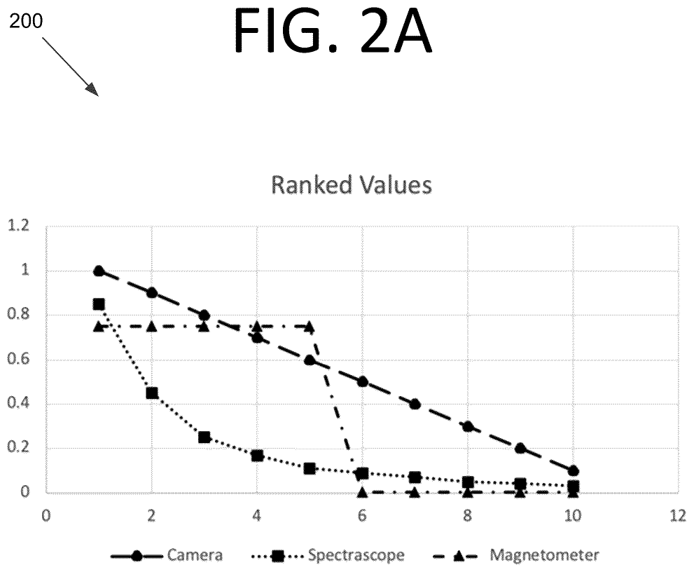

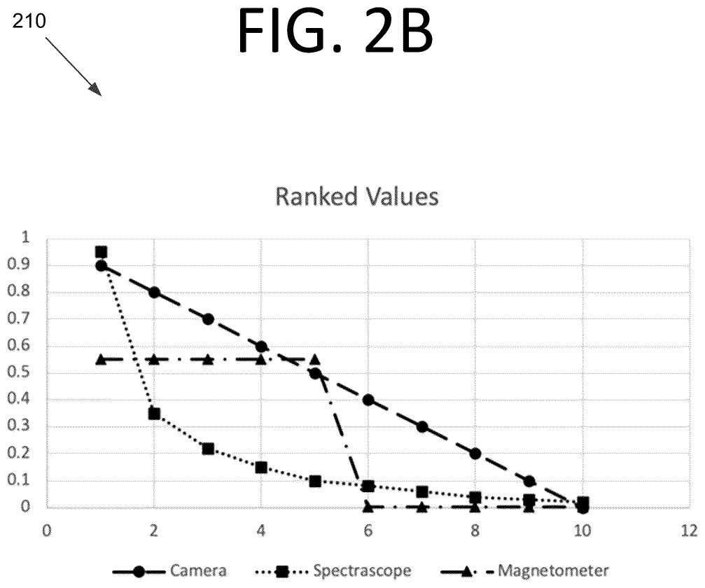

FIGS. 2A and 2B are graphs 200, 210 illustrating ranked values for multiple operations over multiple iterations based on initial value functions for the operations and after user adjustments to the value functions, respectively, according to an embodiment of the present invention. In graph 200, values between 0 and 1 are provided for operations for a camera, a spectroscope, and a magnetometer over 10 iterations based on their respective value functions. In this example, the camera has a decreasing linear value function, the spectrascope has a decreasing exponential value function, and the magnetometer has a decreasing stepwise value function. In some embodiments, these value functions may be assigned in step 150 of FIG. 1.

The user then decides to modify these value functions (e.g., in step 160 of FIG. 1) to better match mission directives. In this case, the user decided to modify the linear value function for the camera such that it starts at 0.9 instead of 1 and decreases by 0.1 each step to 0 instead of 0.1 by step 10. The user also modified the exponential value function of the spectrascope such that its initial value is approximately 0.97, which is now higher than that of the camera. The user further modified the stepwise value function for the magnetometer such that the initial plateau is at 0.55 instead of 0.75.

By using assigned numerical value functions for operations, software agents can quantitatively optimize mission plans against vehicle constraints in a digital twin of the vehicle or a constellation of vehicles. A digital twin of a vehicle or constellation of vehicles incorporates physical models of components, as well as software simulations of the vehicle operations. These models are incorporated in such a way that the digital twin can predict how the operation of the vehicle occurs based on limitations of the vehicle in its environment. The digital twin may include models for battery state of charge that takes input from simulations of payloads and avionics systems, decreasing the state of charge as those systems operate. In some embodiments, the digital twin may include models of the vehicle pointing and attitude control system, including the pointing of key vehicle components (e.g., payload camera orientation, solar panel pointing relative to the sun, antenna orientation, etc.), and/or thermal simulations of the vehicle and its components. Software agents may start with a randomly devised plan and execute the plan, and the digital twin simulation of vehicle capabilities restricts the plans of the agent to possible processes by rejecting plans that are invalid (e.g., plans that use too much energy, require pointing in two directions at once (e.g., operation A and operation B require pointing in different, incompatible directions), certain payloads cannot operate at the same time, etc.). These are the “rules” of the process.

The most successful plans as defined though generating a score for that mission plan based on the mission operation values generated in steps 110 through 170 of FIG. 1, for example, are used, with the most successful or valuable plans being defined as having the highest sum operation value. The highest scoring plans may then be mutated to generate successive generations of plans that are simulated and scored. Mutation of the scoring plans may occur in a directed form where plans are altered in a predetermined path. For example, each step start and/or end time may be altered by X %, the ordering of steps may be flipped, individual steps may be be added or subtracted from the test plan, random changes may be made to any of the parameters of the plan (e.g., step start/stop times, duration, vehicle pointing, power, and/or data collection/transmission rates), etc. This process may be repeated until the plan values no longer change by more than a certain total value (Δ), as defined by the user.

This process not only generates an optimized mission plan, but also provides a trained software agent for future scheduling, speeding up the optimization process for future plans for this vehicle/mission. Once the iteration process has been used to train a software agent for operation of the vehicle to generate mission plans, an updated scoring rubric can be input to the software agent (e.g., when an imaging target is no longer interesting, or a payload test is no longer needed), whereupon the software agent can then reoptimize the mission plan to meet changes in mission value. In addition to being able to respond to changing value of mission operation, changes in the vehicle capability can be input into the digital twin portion of the software agent. This may restrict the missions possible, and the software agent can then optimize against the new vehicle constraints. For example, a micrometeor strike can damage a solar panel, resulting in less power available to the vehicle, though still allowing operation. This reduced power availability may limit the operation of high power laser communications more than a low power camera, and optimizing against these new constraints using the existing value functions (or a new input value function) can deliver a new optimized mission plan.

The digital twin should be able to generate vehicle performance parameters, such as power usage/generation, pointing, orbital elements, thermal conditions, etc. This forms the basis for the process to be performed by the software optimization agent. A high fidelity digital twin should be provided since digital twins built from low resolution telemetry or vehicle specifications may not have sufficient performance accuracy to allow for optimization. The Operations user can then generate the quantified payload values, as well as other “goods” for the mission. Quantified goods may include, but are not limited to, contingency limits, reserve capacity, minimization of system wear, etc. These goods can be defined as hard limits for the digital twin or negative value holders (e.g., exceeding a particular battery discharge margin has a negative value of 10/Wh and then could be scored against the value of an operation that exceeded that margin). Mission optimization can be performed when mission needs change or vehicle capability changes, for example.

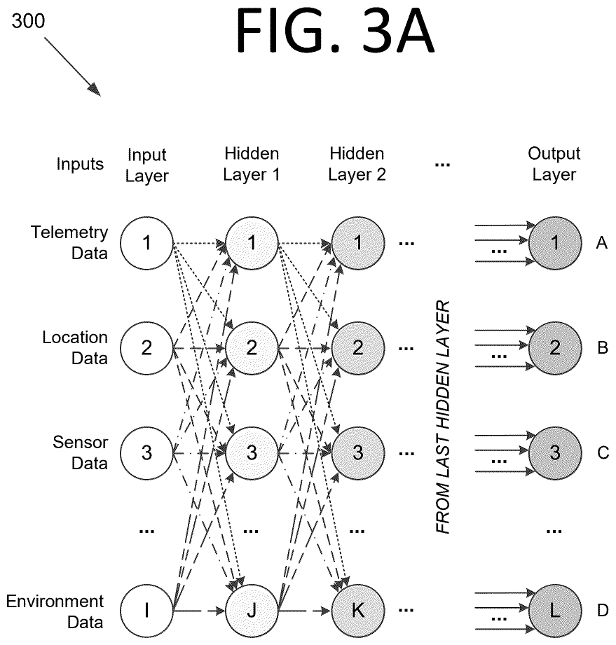

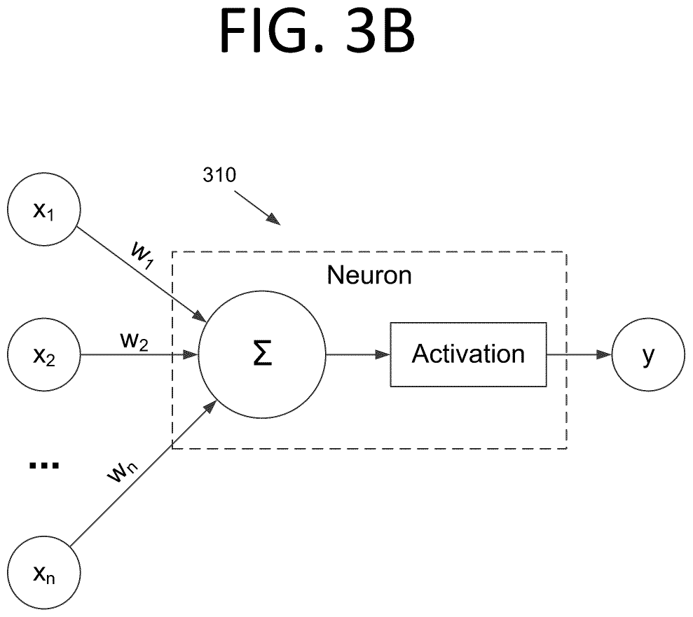

Artificial intelligence (AI)/machine learning (ML) may be used to improve the process of some embodiments. Various types of AI/ML models may be trained and deployed without deviating from the scope of the invention. For instance, FIG. 3A illustrates an example of a neural network 300 that has been trained to perform or supplement intelligent mission optimization, according to an embodiment of the present invention.

Neural network 300 also includes a number of hidden layers. Both DLNNs and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 400.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 3A, telemetry data, location data, sensor data, data pertaining to the operating environment, etc. provided as the input layer are fed as inputs to the J neurons of hidden layer 1. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. It should be noted that numbers of neurons I, J, K, and L are not necessarily equal, and thus, any desired number of layers may be used for a given layer of neural network 300 without deviating from the scope of the invention. Indeed, in certain embodiments, the types of neurons in a given layer may not all be the same.

Neural network 300 is trained to assign a confidence score to appropriate outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be used and the rest may be ignored.

It should be noted that neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative ∞ and positive ∞, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 310 is shown in FIG. 3B. Inputs x₁, x₂, . . . , xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function f(x) to determine whether the neuron “fires”. For instance, f(x) may be given by:

$$f ( x ) = \{ \begin{matrix}1 & if \sum wx + bias \geq 0 \\ 0 & if \sum wx + bias < 0\end{matrix} \qquad ( 2 )$$

The output y of neuron 310 may thus be given by:

$$y = f ( x ) {\sum }_{i = 1}^{m} ( {w}_{i} {x}_{i} ) + bias \qquad ( 3 )$$

In this case, neuron 310 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

The goal, or “reward function” is often employed, such as for this case the successful identification of graphical elements in the image. A reward function explores intermediate transitions and steps with both short-term and long-term rewards to guide the search of a state space and attempt to achieve a goal.

During training, various labeled data is fed through neural network 300. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions fᵢ between each layer i=1, . . . , N of the network, with the output at a given layer first multiplied by a synaptic matrix Wᵢ, and with a bias vector bᵢ added. The network output o, given by

$$o = {f}_{N} ( {W}_{N} {f}_{N - 1} ( {W}_{N - 1} {f}_{N - 2} ( … {f}_{1} ( {W}_{1} x + {b}_{1} ) … ) + {b}_{N - 1} ) + {b}_{N} ) \qquad ( 4 )$$

In some embodiments, o is compared with a target output t, resulting in an error

$$E = \frac{1}{2} {‖ o - t ‖}^{2} ,$$

which is desired to be minimized.

Optimization in the form of a gradient descent procedure may be used to minimize the error by modifying the synaptic weights Wᵢ for each layer. The gradient descent procedure requires the computation of the output o given an input x corresponding to a known target output t, and producing an error o−t. This global error is then propagated backwards giving local errors for weight updates with computations similar to, but not exactly the same as, those used for forward propagation. In particular, the backpropagation step typically requires an activity function of the form pⱼ(nⱼ)=fⱼ′(nⱼ), where nⱼ is the network activity at layer j (i.e., nⱼ=Wⱼoⱼ₋₁+bⱼ) where oⱼ=fⱼ(nⱼ) and the apostrophe ' denotes the derivative of the activity function f.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{new} = {W}_{j}^{old} - η \frac{\partial E}{\partial {W}_{j}} \qquad ( 8 )$$

$${b}_{j}^{new} = {b}_{j}^{old} - η \frac{\partial E}{\partial {b}_{j}} \qquad ( 9 )$$

where ∘ denotes a Hadamard product (i.e., the element-wise product of two vectors), ^{T} denotes the matrix transpose, and oⱼ denotes fⱼ(Wⱼoⱼ₋₁+bⱼ), with o₀=x. Here, the learning rate η is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data, but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. This may collectively allow the AI/ML models to enable semantic understanding to better predict event-based congestion or service interruptions due to an accident, for instance.

Clustering algorithms may be used to find similarities between groups of elements. Clustering algorithms may include, but are not limited to, density-based algorithms, distribution-based algorithms, centroid-based algorithms, hierarchy-based algorithms. K-means clustering algorithms, the DBSCAN clustering algorithm, the Gaussian mixture model (GMM) algorithms, the balance iterative reducing and clustering using hierarchies (BIRCH) algorithm, etc. Such techniques may also assist with categorization.

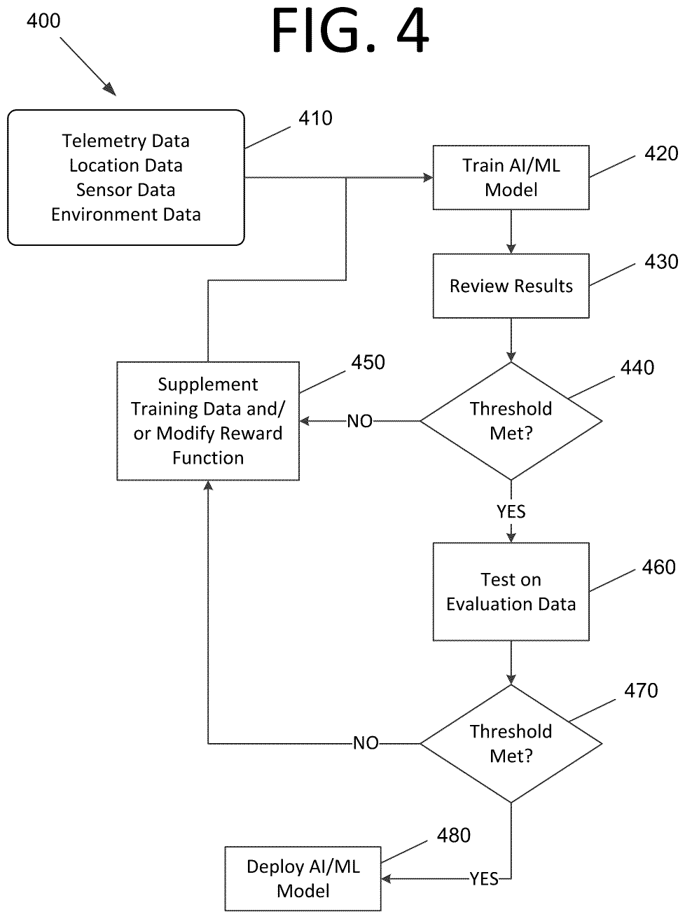

FIG. 4 is a flowchart illustrating a process 400 for training AI/ML model(s), according to an embodiment of the present invention. In some embodiments, the AI/ML model(s) may be generative AI model(s). Generative AI can generate various types of content, such as code, text, imagery, audio, and synthetic data. Various types of generative AI models may be used, including, but not limited to, large language models (LLMs), generative adversarial networks (GANs), variational autoencoders (VAEs), transformers, etc. The process begins with providing training data, such as telemetry data, location data, sensor data, data from the local operating environment, etc. at 410, whether labeled or unlabeled. Other training data used in addition to or in lieu of the training data shown in FIG. 4. Indeed, the nature of the training data that is provided will depend on the objective that the AI/ML model is intended to achieve. The AI/ML model is then trained over multiple epochs at 420 and results are reviewed at 430.

If the AI/ML model fails to meet a desired confidence threshold at 440, the training data is supplemented and/or the reward function is modified to help the AI/ML model achieve its objectives better at 450 and the process returns to step 420. If the AI/ML model meets the confidence threshold at 440, the AI/ML model is tested on evaluation data at 460 to ensure that the AI/ML model generalizes well and that the AI/ML model is not over fit with respect to the training data. The evaluation data includes information that the AI/ML model has not processed before. If the confidence threshold is met at 470 for the evaluation data, the AI/ML model is deployed at 480. If not, the process returns to step 450 and the AI/ML model is trained further.

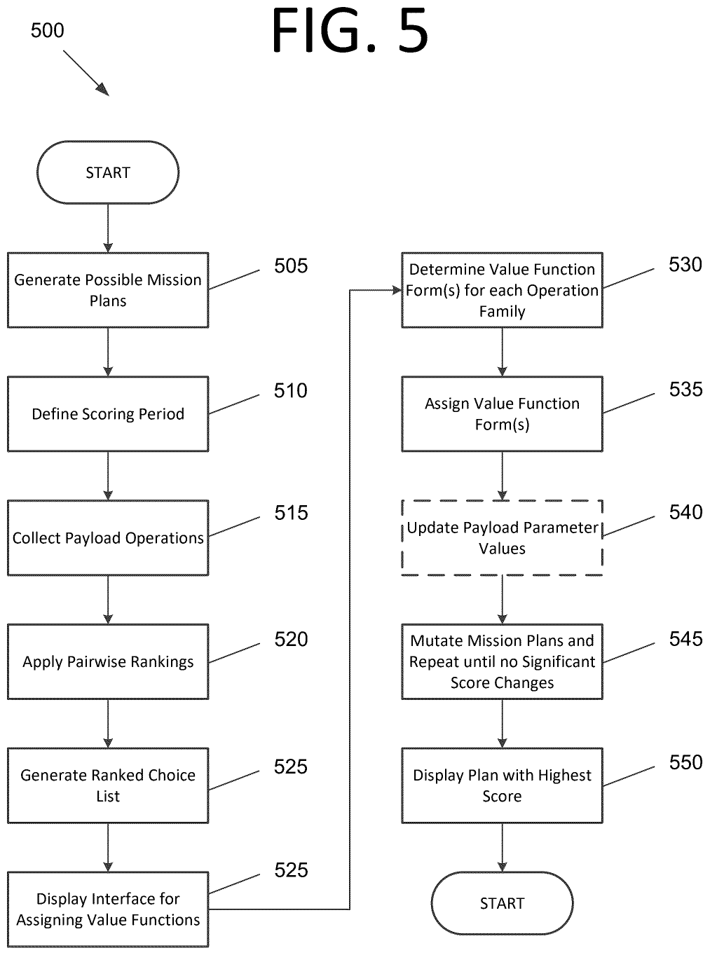

FIG. 5 is flowchart illustrating a process 500 for intelligent mission planning and execution for one or more space vehicles through intelligent analysis of mission objectives and payload operation, according to an embodiment of the present invention. The process begins with generating possible mission plans using a vehicle/mission simulation agent at 505 by running mission/vehicle simulations based on parameters pertaining to operation of systems of the space vehicle(s), payloads of the space vehicle(s), operations of the space vehicle(s), or a combination thereof. In some embodiments, the parameters pertain to pointing requirements, power draw, charging characteristics, orbital alignment, or any combination thereof. In certain embodiments, the running of the mission/vehicle simulations includes analyzing power constraints, attitude constraints, communications bandwidth, thermal conditions, and orbital position. In some embodiments, the vehicle/mission simulation agent includes one or more respective digital twins of the space vehicle(s). The digital twin(s) include space vehicle constraints for the respective space vehicle. In certain embodiments, the digital twin(s) incorporate physical models of space vehicle components and include simulations of space vehicle operations.

A scoring period for the mission/vehicle simulations is defined at 510. The scoring period is a timeframe over which the mission is to be optimized. In some embodiments, the intelligent mission planning is performed for multiple space vehicles across a constellation. Payload operations are collected for the space vehicle(s) at 515 and pairwise rankings are applied to values for the collected payload operations at 520 to establish a relative value for each operation. The pairwise rankings use a common scale. In some embodiments, the pairwise rankings are provided for each repeat of an operation during the scoring period.

A ranked choice list is generated for the payload operations and their repeats during the scoring period using the pairwise rankings at 525. Value function form(s) are determined for each operation family of the payload operations at 530 based on input from the interface. The value function includes a function type and associated weights. In some embodiments, the function type(s) include a decay function, a linear function, an exponential function, a stepwise function, or any combination thereof. The determined value function form(s) for each operational family are assigned at 535 for scoring the generated possible mission plans. In some embodiments, the interface includes graphs of values of the payload operations versus time or versus repeat number and the interface is configured to allow a user to adjust the values of the payload operations versus time or increase and decrease the values of each repeat number. In certain embodiments, the vehicle/mission simulation agent may be updated with updated payload parameter values at 540 if these parameter values change.

The mission plans with a score above a predetermined amount are mutated at 545 to generate successive generations of the mission plans. This process is repeated until the scores do not change significantly (e.g., by no more than a total value (A)). The mission plan with the highest total objective score is then displayed at 550. In some embodiments, the total objective score is based on the output from one or more AI/ML models. This mission plan can then be executed by the space vehicle(s).

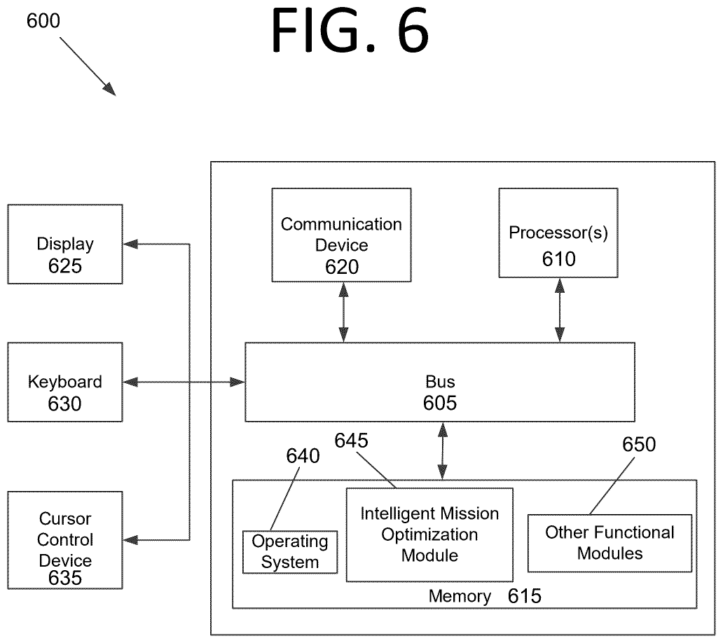

FIG. 6 is an architectural diagram illustrating a computing system 600 configured to perform or supplement intelligent mission optimization, according to an embodiment of the present invention. Computing system 600 includes a bus 605 or other communication mechanism for communicating information, and processor(s) 610 coupled to bus 605 for processing information. Processor(s) 610 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 610 may also have multiple processing cores, and at least some of the cores may be configured to perform specific functions. Multi-parallel processing may be used in some embodiments. In certain embodiments, at least one of processor(s) 610 may be a neuromorphic circuit that includes processing elements that mimic biological neurons. In some embodiments, neuromorphic circuits may not require the typical components of a Von Neumann computing architecture.

Computing system 600 further includes a memory 615 for storing information and instructions to be executed by processor(s) 610. Memory 615 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 610 and may include volatile media, non-volatile media, or both. The media may also be removable, non-removable, or both.

Additionally, computing system 600 includes a communication device 620, such as a transceiver, to provide access to a communications network via a wireless and/or wired connection. In some embodiments, communication device 620 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 620 may include one or more antennas that are singular, arrayed, phased, switched, beamforming, beamsteering, a combination thereof, and or any other antenna configuration without deviating from the scope of the invention.

Processor(s) 610 are further coupled via bus 605 to a display 625, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 625 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 630 and a cursor control device 635, such as a computer mouse, a touchpad, etc., are further coupled to bus 605 to enable a user to interface with computing system 600. However, in certain embodiments, a physical keyboard and mouse may not be present, and the user may interact with the device solely through display 625 and/or a touchpad (not shown). Any type and combination of input devices may be used as a matter of design choice. In certain embodiments, no physical input device and/or display is present. For instance, the user may interact with computing system 600 remotely via another computing system in communication therewith, or computing system 600 may operate autonomously.

Memory 615 stores software modules that provide functionality when executed by processor(s) 610. The modules include an operating system 640 for computing system 600. The modules further include an intelligent mission optimization module 645 that is configured to perform all or part of the processes described herein or derivatives thereof. Computing system 600 may include one or more additional functional modules 650 that include additional functionality.

One skilled in the art will appreciate that a “computing system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIGS. 4 and 5 may be performed by computer program(s), encoding instructions for the processor(s) to perform at least part of the process(es) described in FIGS. 4 and 5, in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 610 of computing system 600 of FIG. 6) to implement all or part of the process steps described in FIGS. 4 and 5, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. One or more non-transitory computer-readable media storing one or more computer programs for intelligent optimization of mission planning and execution for one or more space vehicles through intelligent analysis of mission objectives and payload operation, the one or more computer programs configured to cause at least one processor to:
generate possible mission plans, by a vehicle/mission simulation agent, by running mission/vehicle simulations based on parameters pertaining to operation of systems of the one or more space vehicles, payloads of the one or more space vehicles, operations of the one or more space vehicles, or a combination thereof;
score the generated possible mission plans based on total objective scoring of individual values of component operations within the generated possible mission plans using the parameters, producing respective total objective scores; and
display a mission plan of the generated possible mission plans with a highest total objective score of the respective total objective scores.

2. The one or more non-transitory computer-readable media of claim 1, wherein the parameters pertain to pointing requirements, power draw, charging characteristics, orbital alignment, or any combination thereof.

3. The one or more non-transitory computer-readable media of claim 1, wherein the intelligent mission planning is performed for multiple space vehicles across a constellation.

4. The one or more non-transitory computer-readable media of claim 1, wherein the one or more computer programs are configured to cause at least one processor to:
update the vehicle/mission simulation agent with updated payload parameter values.

5. The one or more non-transitory computer-readable media of claim 1, wherein the running of the mission/vehicle simulations comprises analyzing power constraints, attitude constraints, communications bandwidth, thermal conditions, and orbital position.

6. The one or more non-transitory computer-readable media of claim 1, wherein the one or more computer programs are configured to cause at least one processor to:
define a scoring period for the mission/vehicle simulations, wherein the scoring period is a timeframe over which the mission is to be optimized;
collect payload operations for the one or more space vehicles; and
apply pairwise rankings to values for the collected payload operations to establish a relative value for each operation, wherein the pairwise rankings use a common scale.

7. The one or more non-transitory computer-readable media of claim 6, wherein the pairwise rankings are provided for each repeat of an operation during the scoring period.

8. The one or more non-transitory computer-readable media of claim 7, wherein the one or more computer programs are configured to cause at least one processor to:
generate a ranked choice list for the payload operations and their repeats during the scoring period using the pairwise rankings.

9. The one or more non-transitory computer-readable media of claim 7, wherein the one or more computer programs are configured to cause at least one processor to:
display an interface for assigning value functions;
determine a value function form for each operation family of the payload operations based on input from the interface, the value function comprising a function type and associated weights; and
assign the determined value function form for each operational family for scoring the generated possible mission plans.

10. The one or more non-transitory computer-readable media of claim 9, wherein the function type comprises a decay function, a linear function, an exponential function, or a stepwise function.

11. The one or more non-transitory computer-readable media of claim 9, wherein
the displaying of the interface comprises displaying graphs of values of the payload operations versus time or versus repeat number, and
the interface is configured to allow a user to adjust the values of the payload operations versus time or increase and decrease the values of each repeat number.

12. The one or more non-transitory computer-readable media of claim 1, wherein
the vehicle/mission simulation agent comprises one or more respective digital twins of the one or more space vehicles, and
the one or digital twins comprise space vehicle constraints for the respective space vehicle of the one or more space vehicles.

13. The one or more non-transitory computer-readable media of claim 12, wherein the one or more digital twins incorporate physical models of space vehicle components and comprise simulations of space vehicle operations.

14. The one or more one or more non-transitory computer-readable media of claim 1, wherein the one or more computer programs are configured to cause at least one processor to:
mutate plans of the generated possible mission plans with a score above a predetermined amount to generate successive generations of the possible mission plans; and
repeat the process of mutating the plans until a change in the scores is by no more than a total value (Δ).

15. The one or more one or more non-transitory computer-readable media of claim 14, wherein the one or more computer programs are configured to cause the at least one processor to:
provide the parameters to one or more artificial intelligence (AI)/machine learning (ML) models that have been trained based on telemetry data, location data, vehicle sensor data, data from an operating environment of space vehicles, vehicle component data, vehicle and/or payload constraint data, or any combination thereof;
receive one or more outputs from the one or more AI/ML models comprising the scores for the possible mission plans; and
assign the respective total objective scores based on the output from the one or more AI/ML models.

16. The one or more one or more non-transitory computer-readable media of claim 15, wherein the one or more computer programs are configured to cause the at least one processor to:
provide the telemetry data, the location data, the vehicle sensor data, the data from the operating environment of the space vehicles, the vehicle component data, the vehicle and/or payload constraint data, or the combination thereof to the one or more AI/ML models;
train the one or more AI/ML models over multiple epochs until a training data target confidence threshold is achieved;
test the one or more AI/ML models on evaluation data until an evaluation data target confidence threshold is achieved; and
deploy the one or more AI/ML models.

17. A computing system, comprising:
memory storing computer program instructions for intelligent optimization of mission planning and execution for one or more space vehicles through intelligent analysis of mission objectives and payload operation; and
at least one processor configured to execute the computer program instructions, wherein the computer program instructions are configured to cause the at least one processor to:
define a scoring period for mission/vehicle simulations, wherein the scoring period is a timeframe over which the mission is to be optimized,
collect payload operations for the one or more space vehicles,
apply pairwise rankings to values for the collected payload operations to establish a relative value for each operation, wherein the pairwise rankings use a common scale,
score possible mission plans based the pairwise rankings, and
display a mission plan of the generated possible mission plans with a highest total objective score of the respective total objective scores.

18. The computing system of claim 17, wherein the computer program instructions are further configured to cause the at least one processor to:
generate the possible mission plans, by a vehicle/mission simulation agent, by running mission/vehicle simulations based on parameters pertaining to payloads of the one or more space vehicles, pointing requirements, power draw, charging characteristics, orbital alignment, or any combination thereof, wherein
the vehicle/mission simulation agent comprises one or more respective digital twins of the one or more space vehicles, and
the one or digital twins comprise space vehicle constraints for the respective space vehicle of the one or more space vehicles.

19. The computing system of claim 17, wherein the pairwise rankings are provided for each repeat of an operation during the scoring period.

20. The computing system of claim 17, wherein the computer program instructions are further configured to cause the at least one processor to:
generate a ranked choice list for the payload operations and their repeats during the scoring period using the pairwise rankings.

21. The computing system of claim 17, wherein the computer program instructions are further configured to cause the at least one processor to:
display an interface for assigning value functions;
determine a value function form for each operation family of the payload operations based on input from the interface, the value function comprising a function type and associated weights; and
assign the determined value function form for each operational family for scoring the generated possible mission plans.

22. The computing system of claim 21, wherein
the displaying of the interface comprises displaying graphs of values of the payload operations versus time or versus repeat number, and
the interface is configured to allow a user to adjust the values of the payload operations versus time or increase and decrease the values of each repeat number.

23. The computing system of claim 17, wherein the computer program instructions are further configured to cause the at least one processor to:
mutate plans of the generated possible mission plans with a score above a predetermined amount to generate successive generations of the possible mission plans; and
repeat the process of mutating the plans until a change in the scores is by no more than a total value (Δ).

24. The computing system of claim 17, wherein the computer program instructions are further configured to cause the at least one processor to:
provide the parameters to one or more artificial intelligence (AI)/machine learning (ML) models that have been trained based on telemetry data, location data, vehicle sensor data, data from an operating environment of space vehicles, vehicle component data, vehicle and/or payload constraint data, or any combination thereof;
receive one or more outputs from the one or more AI/ML models comprising the scores for the possible mission plans; and
assign the respective total objective scores based on the output from the one or more AI/ML models.

25. A computer-implemented method for intelligent optimization of mission planning and execution for one or more space vehicles through intelligent analysis of mission objectives and payload operation, comprising:
generating possible mission plans, by a vehicle/mission simulation agent executing on a computing system, by running mission/vehicle simulations based on parameters pertaining to operation of systems of the one or more space vehicles, payloads of the one or more space vehicles, operations of the one or more space vehicles, or a combination thereof;
scoring the generated possible mission plans, by the computing system, based on total objective scoring of individual values of component operations within the generated possible mission plans using the parameters, producing respective total objective scores; and
displaying a mission plan of the generated possible mission plans with a highest total objective score of the respective total objective scores, by the computing system, wherein
the running of the mission/vehicle simulations comprises analyzing power constraints, attitude constraints, communications bandwidth, thermal conditions, and orbital position.

26. The computer-implemented method of claim 25, further comprising:
defining a scoring period for the mission/vehicle simulations, by the computing system, wherein the scoring period is a timeframe over which the mission is to be optimized;
collecting payload operations for the one or more space vehicles, by the computing system; and
applying pairwise rankings to values for the collected payload operations to establish a relative value for each operation, by the computing system, wherein the pairwise rankings use a common scale.

27. The computer-implemented method of claim 26, wherein the pairwise rankings are provided for each repeat of an operation during the scoring period.

28. The computer-implemented method of claim 27, wherein the one or more computer programs are configured to cause at least one processor to:
generate a ranked choice list for the payload operations and their repeats during the scoring period using the pairwise rankings.

29. The computer-implemented method of claim 27, further comprising:
displaying an interface for assigning value functions, by the computing system;
determining, by the computing system, a value function form for each operation family of the payload operations based on input from the interface, the value function comprising a function type and associated weights; and
assigning the determined value function form for each operational family for scoring the generated possible mission plans, by the computing system.

30. The computer-implemented method of claim 27, wherein
the displaying of the interface comprises displaying graphs of values of the payload operations versus time or versus repeat number, and
the interface is configured to allow a user to adjust the values of the payload operations versus time or increase and decrease the values of each repeat number.

31. The computer-implemented method of claim 25, wherein
the vehicle/mission simulation agent comprises one or more respective digital twins of the one or more space vehicles,
the one or digital twins comprise space vehicle constraints and physical models of space vehicle components and comprise simulations of space vehicle operations for the respective space vehicle of the one or more space vehicles.

32. The computer-implemented method of claim 25, further comprising:
mutating plans of the generated possible mission plans with a score above a predetermined amount to generate successive generations of the possible mission plans, by the computing system; and
repeating the process of mutating the plans, by the computing system, until a change in the scores is by no more than a total value (Δ).

33. The computer-implemented method of claim 25, further comprising:
providing the parameters, by the computing system, to one or more artificial intelligence (AI)/machine learning (ML) models that have been trained based on telemetry data, location data, vehicle sensor data, data from an operating environment of space vehicles, vehicle component data, vehicle and/or payload constraint data, or any combination thereof;
receiving one or more outputs from the one or more AI/ML models comprising the scores for the possible mission plans, by the computing system; and
assigning the respective total objective scores based on the output from the one or more AI/ML models, by the computing system.
